(19) United States
(12) Patent Application Publication
(10) Pub. No.: US 2004/0049441 A1
(43) Pub. Date: Mar. 11, 2004

(54) Process for purchasing fossil fuels using equity or equity-cash as the payment means

(76) Inventors: Nasser Menhall, Cambridge, MA (US); Oussama Salam, Paris (FR)

Correspondence Address: Loletta Darden, Sachnoff & Weaver, Ltd., 30 South Wacker Drive, 29th Floor, Chicago, IL, 60606, US

(21) Appl. No.: 10/264,484

(22) Filed: Oct. 4, 2002

Related U.S. Application Data
(60) Provisional application No. 60/408,603, filed on Sep. 6, 2002.

(51) Int. Cl. G06F 17/60

(52) U.S. Cl. 705/35; 705/39

(57) ABSTRACT

A process for purchasing fossil fuel, e.g. natural liquid gas, using a combination of equity and cash as the payment means, comprising the steps of determining a total volume of fossil fuel to be delivered over time; allocating a percentage of a total purchase price to be paid in cash and an amount to be paid by a transfer of equity, wherein the equity traded shall be restricted from sale into the public markets for a predetermined time period, and the restriction period shall begin to run on the date the partial shipment arrives at a designated location; delivering shipments of fossil fuel that represent partial shipments of the total volume of fossil fuel to be delivered; determining the cash value of the partial shipments; determining the cash payment due based on the value of the partial shipment; determining the agreed-to percentage of the purchase price to be in cash; determining the equity to be transferred based on the value of the shipment and the agreed-to percentage of the purchase price to be paid for in equity; and transferring cash, equity or both as payment for the partial shipment.

### CROSS REFERENCE TO RELATED APPLICATIONS

Applicants hereby claim priority of provisional application Serial No. 60/408,603 filed on Sep. 6, 2002, entitled “Method for Purchasing Fossil Fuels Using Equity or Equity-Cash as the Payment Means.”

### FIELD OF THE INVENTION

The invention relates to a process for trading a predetermined quantity of one or more fossil fuels such as liquid natural gas (“LNG”) or oil against equity shares, common or preferred or both, in the company purchasing the fossil fuel.

### BACKGROUND OF THE INVENTION

As human beings become more and more dependent on technology, our need for electrical energy also increases. This demand for electrical energy is expected to grow substantially over the next twenty years. The Annual Energy Outlook 2002 report projects that “electricity demand is projected to grow by 1.8 percent per year from 2000 through 2020 . . . . The most rapid growth is expected for computers, office equipment, and a variety of residential and commercial appliances and equipment.” Not only are electrical energy needs predicted to increase, the Annual Energy Outlook 2002 report also projects that “[t]otal energy consumption is expected to increase more rapidly than domestic energy production through [year] 2020.” Thus, in the United States, increasing energy demands, and in particular the demand for electrical energy, are expected to be met by importing the resources necessary to produce the needed energy.

Turning specifically to electrical energy production, the resources for producing electrical energy include fossil fuels, uranium and water. The Energy Information Administration reports that “[f]ossil fuels supply about 70 percent of the energy sources” needed to produce electrical power in the United States.

In recent years, more and more United States electrical power producing companies have been turning to foreign sources of fossil fuels, e.g., LNG or oil, due to the shrinking volume of mineable domestic sources. For instance, only a few very large gas fields have been discovered in the United States since 1990. Further, there are major restrictions on the opening of new nuclear plants, and air-quality concerns have led to national and local moratoriums on new coal generation plants; consequently, domestic energy suppliers have turned to sources outside the U.S. for fuel to produce electrical power. Thus, it is likely that the resources for producing electrical energy will be supplied by sources outside the United States.

The cost of purchasing and transporting fossil fuels over great distances can be cost prohibitive, particularly to cash-strapped electrical energy power generation companies. Often an electrical power generation company finds itself faced with the following scenario: (1) locating sources of capital, (2) formulating plans and obtaining permits, (3) building/upgrading plants, and (4) locating sources of fossil fuels. However, the lag time between locating capital sources and the actual production of electrical power for sale may severely impact the ability of power companies to meet existing energy demands or to remain viable and competitive. Thus, there is needed a methodology for securing sources of fossil fuel that does not impose substantial cash burdens on the buyer.

### SUMMARY OF THE INVENTION

The invention relates to a method for trading fossil fuel reserves, particularly gas reserves, against equity in the company purchasing the fuel. Alternatively, the fossil fuel may be traded against a combination of equity in the purchasing company and cash. Such a purchasing scheme reduces the upfront cash outlay required by electrical power producers in purchasing the raw materials needed to produce power for sale. By simultaneously sourcing their fossil fuel and capital requirements in one transaction, energy generating companies may benefit from a sudden increase in their debt ratings because their perceived credit risk will greatly diminish. This may allow them to borrow further in order to build more plants and further improve their profitability, which in turn should allow them to raise equity in the capital markets. In this manner, electricity shortages may be averted and very long-term gas reserves may be commercialized.

Specifically the process includes the steps of determining a total volume of fossil fuel to be delivered over time; allocating a percentage of a total purchase price to be paid in cash and an amount to be paid by a transfer of equity, wherein the equity traded shall be restricted from sale into the public markets for a predetermined time period, and the restriction period shall begin to run on the date the partial shipment arrives at a designated location; delivering shipments of fossil fuel that represent partial shipments of the total volume of fossil fuel to be delivered; determining the cash value of the partial shipments; determining the cash payment due based on the value of the partial shipment; determining the agreed-to percentage of the purchase price to be in cash; determining the equity to be transferred based on the value of the shipment and the agreed-to percentage of the purchase price to be paid for in equity; and transferring cash, equity or both as payment for the partial shipment.

### BRIEF DESCRIPTION OF THE DRAWINGS

FIG. 1 shows a flowchart that highlights the major aspects of a fossil fuel purchasing scheme executed in accordance with the teachings of this invention.

### DETAILED DESCRIPTION OF PREFERRED EMBODIMENTS

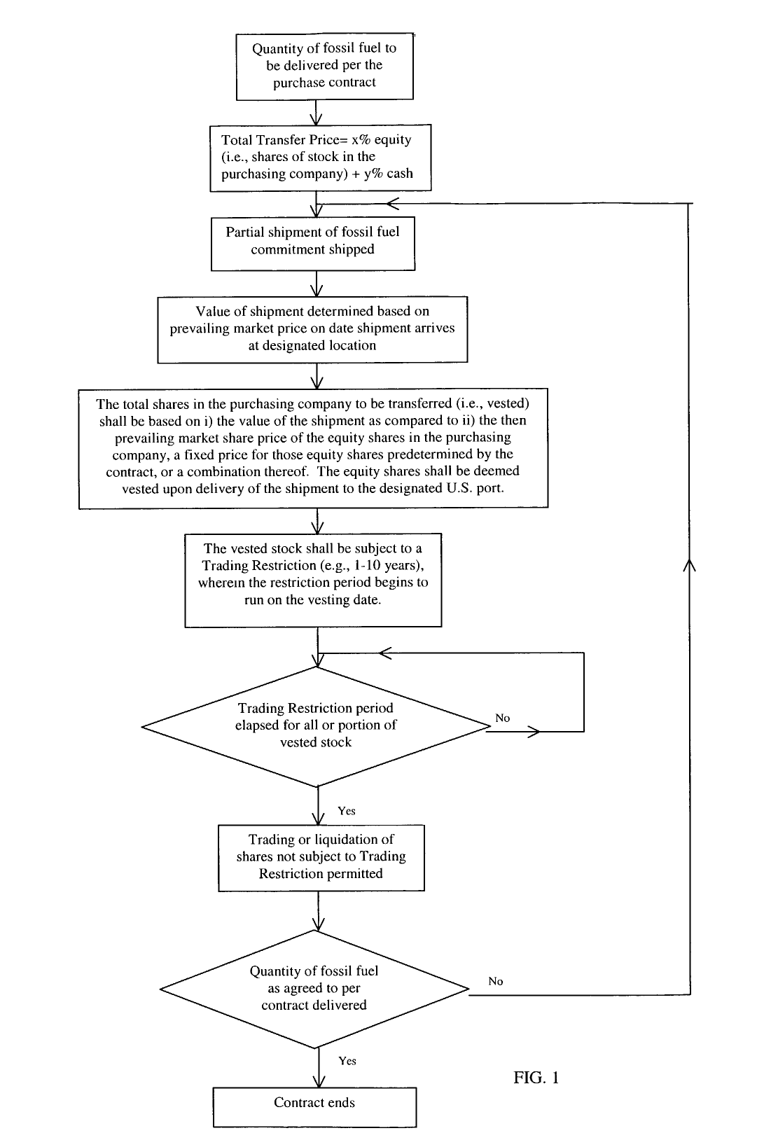

As best seen in FIG. 1, the invention relates to a process for purchasing fossil fuel using equity or a combination of equity and cash as the means of payment. More particularly, the invention has particular application to a process for purchasing a quantity of the fossil fuel reserves, e.g., liquid natural gas or oil, of one or more countries. Thus, the invention provides a country with a current customer for reserves that normally would go unmarketed, and thus permits the accumulation of value for future generations.

FIG. 1 illustrates one method for implementing a purchasing process for purchasing fossil fuel as taught by the invention. As shown in FIG. 1, the buyer and seller must agree, at some point, to a quantity of fossil fuel to be sold and delivered to the buyer. Preferably, the agreed-to quantity of fossil fuel will be delivered over a specified time period.

The total transfer price for the fossil fuel is preferably allocated between equity (i.e., shares of stock) in the purchasing company (x %) plus cash (y %), where x+y=100%. For example, if the equity commitment comprises forty percent (40%) of the purchase price, the remaining sixty percent (60%) of the purchase price will be made in cash.

It will be appreciated that remittance of the transfer price may comprise any combination of equity/cash transfers/payments that will be applied toward the amount due. For example, the first five shipments may require a cash payment and the remaining shipment to be paid for with a combination of cash and equity. It will be further appreciated that the equity shares may be the shares of the buyer company, shares of a third party or shares in an association of companies. However, as will be explained below, the equity and cash shall be delivered to the seller over time based upon delivery of partial shipments of the fossil fuel to the purchaser.

As shown in FIG. 1, partial shipments of the fossil fuel are to be made periodically during the term of the purchase contract. Preferably, the contract will have a term of at least ten years. However, the actual term of the contract may vary depending on the nature of the transaction.

The value of the fossil fuel shipped during the term of the purchase contract shall be determined based on the prevailing market price for the particular fuel, e.g., LNG, oil, etc., on the date the shipment arrives at a designated port or other agreed location. The Henry Hub Spot and Futures index or other similar indices may be used to determine the market price for the particular fossil fuel. Additionally, the value of the fossil fuel shipped may be based on an agreed-to price based on a price per volume. Further still, the value of the fossil fuel shipped may be based partially (1) on the prevailing market price at the time the shipment reaches a designated location and (2) an agreed-to price or rate (price/volume).

Once the value of the shipment has been determined, the quantity of equity shares to be transferred against the shipment may be determined. For instance, the total equity shares in the purchasing company to be transferred against the value of the shipment may be based (1) on the then prevailing market share price of the shares to be transferred, (2) a fixed price for those equity shares predetermined by the purchase contract, or (3) a combination thereof.

Once the value of the shipment and the value of the equity shares to be traded have been determined, the shipment value may be used as a guide for transferring an equity interest in the company commensurate with the value of the shipment. In other words, the equity shares are used as the means for paying for all or a part of the fossil fuel shipped.

The equity shares traded in exchange for the fossil fuel shall also be subject to a trading restriction. The length of the trading restriction may vary depending on the nature of the transaction. However, for transactions governed by United States law, the restriction period must comply with the mandates of Regulation S of the Securities Act of 1933. Preferably, the restriction period will range from a minimum of one (1) year to a maximum of ten (10) years. Although equity shares in the purchasing company will be deemed vested on the date the shipment of fossil arrives at a designated port, the trading restriction will begin to run on the vesting date.

The invention will be explained for illustrative purposes with reference to a transaction involving the purchase of LNG:

The LNG would be purchased under a long-term delivery contract having a termination date ten (10) years from the date of execution. The purchase price for the LNG is to be paid partly in cash (0-50%) and partly in equity shares of the buyer (50-100%). The shares in the buyer company will be restricted from sale into the public markets (trading) for a term of ten (10) years. A significant portion of the shares would be blocked in escrow and vested over time. Thus, the vesting period shall be tied to receipt of the shipment and the value of each shipment.

The value of each shipment is to be fixed on the date of arrival of the shipment in the United States at a designated port or any other agreed-upon location. The value of the shipment shall be determined based on prevailing gas market prices using Henry Hub Spot price index or other specified similar indices. Alternatively, the price of the LNG may be based on a pre-fixed price agreed to by the buyer and seller. The equity shares in the buyer company will be vested based on a pre-set valuation of the shares. Alternatively, the equity shares in the buyer company utilized to purchase a particular shipment of LNG may be vested based on the price per share (or a discount thereof) as traded on the open market as of the time of that shipment. Once the shares are fully vested, the deliveries can continue on an all-cash basis, or a new similar transaction may be arranged.

Preferred embodiments of the present invention have been disclosed. A person of ordinary skill in the art would realize, however, that certain modifications would come within the teachings of this invention.

We claim:

1. A process of purchasing fossil fuels, comprising the steps of:
determining a total volume of fossil fuel to be delivered over time;
allocating a percentage of a total purchase price to be paid in cash and an amount to be paid by a transfer of equity, wherein the equity traded shall be restricted from sale into the public markets for a predetermined time period, and the restriction period shall begin to run on the date a partial shipment of the total volume of fossil fuel arrives at a designated location;
delivering shipments of fossil fuel that represent partial shipments of the total volume of fossil fuel to be delivered;
determining the cash value of the partial shipments;
determining the cash payment due based on the value of the partial shipment and the agreed-to percentage of the purchase price to be in cash;
determining the equity to be transferred based on the value of the shipment and the agreed-to percentage of the purchase price to be paid for in equity; and
transferring cash, equity or both as payment for the partial shipment.

2. The method defined in claim 1, wherein the equity to be traded comprises common stock, preferred stock or both.

3. The method defined in claim 2, wherein the stock is stock in the buyer company.

4. The method defined in claim 2, wherein the stock is stock in an association of companies.

5. The method defined in claim 1, wherein the value of the equity to be traded is determined based on the prevailing market price at the time the partial shipment arrives at a designated location.

6. The method defined in claim 1, wherein the value of the equity to be traded is fixed.

7. The method defined in claim 1, wherein the value of the equity to be traded is based partially on the prevailing market price at the time the partial shipment arrives at a designated location and partially on a predetermined price or both.

8. The method defined in claim 1, wherein the value of the partial shipment is determined based on the prevailing market price at the time the partial shipment arrives at a designated location.

9. The method defined in claim 1, wherein the value of the partial shipment is determined based upon an agreed-to price, price per volume or both.

10. The method defined in claim 1, wherein the value of the partial shipment is based partially on the prevailing market price at the time the partial shipment arrives at a designated location and partially on an agreed-to price.

11. The method defined in claim 1, wherein the fossil fuel is liquid natural gas.

12. The method defined in claim 1, wherein the fossil fuel is oil.

13. The method defined in claim 1, wherein the fossil fuel to be sold comprises part of the seller's reserves.
